(19) United States
(12) Patent Application Publication
(10) Pub. No.: US 2016/0356266 A1
(43) Pub. Date: Dec. 8, 2016

(54) System and Method for Reducing Torsional Movement in a Wind Turbine Tower

(71) Applicant: General Electric Company, Schenectady, NY (US)

(72) Inventors: Arne Koerber, Greenville, SC (US); Till Hoffmann, Osnabrueck (DE)

(21) Appl. No.: 14/729,328

(22) Filed: Jun. 3, 2015

(51) Int. Cl. F03D 11/00; F03D 7/04; F03D 11/04; F03D 7/02

(52) U.S. Cl. CPC F03D 11/0091; F03D 7/0224; F03D 7/044; F03D 7/0296; F03D 11/04

(57) ABSTRACT

The present disclosure is directed to a system and method for reducing vibrations of a tower (e.g. a tubular steep tower or a lattice tower structure) of a wind turbine. The method includes continuously determining a torsional movement of the tower based at least in part on measurements obtained from one or more sensors. Another step includes continuously determining, via a controller, a control command for one or more pitch drive mechanisms of the wind turbine based on the torsional movement. Thus, the method also includes operating the one or more pitch drive mechanisms based on the control command so as to dampen the torsional movement of the tower.

### FIELD OF THE INVENTION

The present invention relates to generally to wind turbines, and more particularly, to a system and method for reducing torsional movement of a wind turbine tower.

### BACKGROUND OF THE INVENTION

Wind power is considered one of the cleanest, most environmentally friendly energy sources presently available, and wind turbines have gained increased attention in this regard. A modern wind turbine typically includes a tower, a generator, a gearbox, a nacelle, and a rotor having a rotatable hub with one or more rotor blades. The rotor blades capture kinetic energy of wind using known airfoil principles. The rotor blades transmit the kinetic energy in the form of rotational energy so as to turn a shaft coupling the rotor blades to a gearbox, or if a gearbox is not used, directly to the generator. The generator then converts the mechanical energy to electrical energy that may be deployed to a utility grid.

Like most dynamic systems, wind turbines are subject to undesirable vibrations that may detrimentally impact the operation and/or structural integrity of the wind turbine. Such vibrations often present themselves as bending and/or torsional vibrations within the wind turbine tower. Moreover, these bending and torsional vibrations may have resonance values (e.g., large amplitude oscillations at a specific frequency) within the operating range of the wind turbine. Accordingly, to minimize damage to the wind turbine, wind turbine component design should account for these undesirable vibrations.

In addition, wind turbines with lattice or space frame towers can have low torsional frequencies and low torsional damping, thereby leading to excessive torsional movement, trips, and/or tower damage. More specifically, lattice towers typically have a low natural frequency in the torsional axis as compared to tubular towers. Thus, such towers can be easily excited by turbulent wind because of their lower natural frequency.

One design approach for minimizing torsional vibrations in the wind turbine tower is to structurally reinforce the wind turbine so as to alter its vibration response (e.g., make the tower stiffer). Such a solution, however, may be prohibitively expensive, especially as tower heights continue to increase. Another design approach involves allowing the vibrations and addressing their impact through supplemental systems. In this regard, various vibration dampers have been implemented that reduce or minimize the effects of resonant vibrations in wind turbines. Such dampers may, for example, reduce the large-amplitude oscillations characteristic of resonant behavior. In one form or another, however, these vibration dampers can have certain drawbacks that do not fully address the potential negative impact of resonant vibrations of the wind turbine.

In view of the aforementioned, there is a need for an improved active tower torsion damper for wind turbine towers. More specifically, an active tower torsion damper for lattice towers would be advantageous.

### BRIEF DESCRIPTION OF THE INVENTION

Aspects and advantages of the invention will be set forth in part in the following description, or may be obvious from the description, or may be learned through practice of the invention.

In one aspect, the present disclosure is directed to a method for reducing vibrations of a tower (e.g. a tubular steep tower or a lattice tower structure) of a wind turbine. The method includes continuously determining a torsional movement of the tower based at least in part on measurements obtained from one or more sensors. Another step includes continuously determining, via a controller, a control command for one or more pitch drive mechanisms of the wind turbine based on the torsional movement. Thus, the method also includes operating the one or more pitch drive mechanisms based on the control command so as to dampen the torsional movement of the tower.

In one embodiment, the step of continuously determining the torsional movement of the tower further includes measuring, via one or more linear acceleration sensors, a first movement at a first location of the wind turbine and a second movement at a second location of the wind turbine, and subtracting the measured first movement from the measured second movement. More specifically, in certain embodiments, the first location may include a tower center of the tower, whereas the second location may include a posterior or rear side of the nacelle or an anterior or front side of the nacelle.

In another embodiment, the step of continuously determining the torsional movement of the tower may include: measuring, via one or more sensors, an angular movement of the tower. For example, the angular movement may include an absolute angle, angular velocity, angular acceleration, and/or similar.

In further embodiments, the method may also include filtering the measurements (e.g. the torsional movement measurements) obtained from the one or more sensors.

In additional embodiments, the step of continuously determining the control command for one or more pitch drive mechanisms of the wind turbine based on the torsional movement may include: determining a yaw moment of the wind turbine as a function of the torsional movement and determining a damper command for the wind turbine based on the yaw moment. As used herein, the yaw moment of the tower generally refers to a loading of a rotor of the wind turbine caused by rotor asymmetry. In addition, the damper command generally refers to a command that generates a motion so as to counter the motion of the tower. Thus, in certain embodiments, the damper command may correspond to a yaw moment command that counters movement of the tower due to a current or previous excitation.

In still another embodiment, the step of operating the one or more pitch drive mechanisms based on the control command so as to dampen the torsional movement of the tower may further include operating the one or more pitch drive mechanisms based on the damper command.

In further embodiments, the method may also include continuously determining the torsional movement of the tower via one or more of the pitch drive mechanisms.

In another aspect, the present disclosure is directed to a method for actively controlling a wind turbine so as to reduce vibrations of a tower of the wind turbine. The method includes continuously determining, via one or more yaw drive mechanisms, a torsional movement of the tower. Another step includes continuously determining a yaw moment of the wind turbine as a function of the torsional movement. The method also includes continuously determining a damper command of the wind turbine based on the yaw moment. Thus, the method further includes controlling, via the one or more pitch drive mechanisms, the wind turbine based on the damper command so as to dampen the torsional movement of the tower.

In another aspect, the present disclosure is directed to a system for reducing vibrations of a tower of a wind turbine. The system includes one or more sensors configured to measure a torsional movement of the tower and a controller communicatively coupled with the one or more sensors. The controller is configured to perform one or more operations, including but not limited to: continuously determining a torsional movement of the tower based at least in part on measurements obtained from one or more sensors, continuously determining, via a controller, a control command for one or more pitch drive mechanisms of the wind turbine based on the torsional movement, and operating the one or more pitch drive mechanisms based on the control command so as to dampen the torsional movement of the tower. It should be understood that the controller may be further configured to perform any of the additional steps and/or features described herein.

In addition, the system may further include one or more filters configured to filter the measurements obtained from the one or more sensors, wherein the one or more filters comprise at least one of a notch filter, a low-pass filter, a high-pass filter, or combinations thereof.

In further embodiments, the controller may include at least one of or a combination of the following control devices: a proportional (P) controller, a proportional integral (PI) controller, a proportional derivative (PD) controller, a proportional integral derivative (PID) controller, or similar.

In additional embodiments, the one or more sensors described herein may include any suitable sensors known in the art. For example, in certain embodiments, the one or more sensors may include one or more of the following: angular accelerometers, linear accelerometers, vibration sensors, angle of attack sensors, camera systems, fiber optic systems, gyroscopes, strain gauges, Miniature Inertial Measurement Units (MIMUs), Light Detection and Ranging (LIDAR) sensors, Sonic Detection and Ranging (SODAR) sensors, or similar.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a perspective view of a wind turbine having a lattice tower structure according to the present disclosure;

FIG. 2 illustrates a perspective view of an alternative embodiment of a wind turbine having a lattice tower structure according to the present disclosure;

FIG. 3 illustrates a detailed, perspective view of one embodiment of a nacelle of a wind turbine according to the present disclosure;

FIG. 4 illustrates a block diagram of one embodiment of suitable components that may be included in a controller of the wind turbine;

FIG. 5 illustrates a block diagram of one embodiment of a system for reducing vibrations of the wind turbine that may be implemented by the wind turbine controller according to the present disclosure;

FIG. 6 illustrates a top view of one embodiment of a wind turbine, particularly illustrating a plurality of sensors configured to measure a torsional movement of a tower of the wind turbine;

FIG. 7 illustrates a schematic diagram of another embodiment of a system for reducing vibrations of the wind turbine that may be implemented by the wind turbine controller according to the present disclosure;

FIG. 8 illustrates various graphs depicting the effects implementing a system for active torsional damping of a wind turbine tower according to the present disclosure; and

FIG. 9 illustrates a flow diagram of one embodiment of a method for reducing vibrations of the wind turbine that may be implemented by the wind turbine controller according to the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Modern wind turbines experience an increase in size, which includes an increasing rotor diameter. Thereby, loads on the components of the wind turbine increase as well. This also relates to the tower of the wind turbine, which includes a significant portion of the mass of the entire wind turbine. As a result, in an attempt to withstand the increasing loads by providing stronger or additional materials, the tower experiences the largest increase in mass. According to embodiments described herein, the loads on the tower can be reduced by providing an active damper for the tower. As a result, the loads can be reduced. Thereby, the material strength of the wind turbine or wind turbine components, e.g., the tower, does not need to be increased or may even be reduced.

Generally, the present disclosure is directed to a system and method for actively controlling a wind turbine so as to reduce torsional movements of a tower of the wind turbine. More specifically, in certain embodiments, the system includes one or more sensors for measuring the torsional movement of the machine head, e.g. via an angular movement sensor or linear movement sensors in the tower center and at the end of the generator frame. For example, in certain embodiments, by subtracting the lateral tower movement from the later generator frame movement, the torsional tower movement can be established when filtering around the expected natural frequency. More specifically, the generator frame natural frequency modes are typically much higher, e.g. five times higher, and can therefore be distinguished from the tower natural frequency modes. In additional embodiments, the measurement of the yawing moment, e.g. Q, at the rotor shaft can also be used additionally or exclusively to determine the torsional movement. Thus, using individual pitch control, a yawing moment can be introduced that offsets and therefore damps the unwanted tower torsional movement. Accordingly, the pitch drive mechanisms are fast enough to effectively damp the tower vibrations in the region of natural frequencies.

The present disclosure provides many advantages not present in the prior art. For example, the active damping system according to the present disclosure can be implemented without additional cost to the wind turbine by using existing sensors, e.g. accelerometers, and pitch drive mechanisms. Further, the system of the present disclosure reduces tower vibrations in torsionally weak towers, such as lattice tower structures. These tower designs in turn enable higher hub heights at a lower cost, thereby allowing turbines to be built at low wind speed sites where the cost for the tower would be otherwise prohibitive.

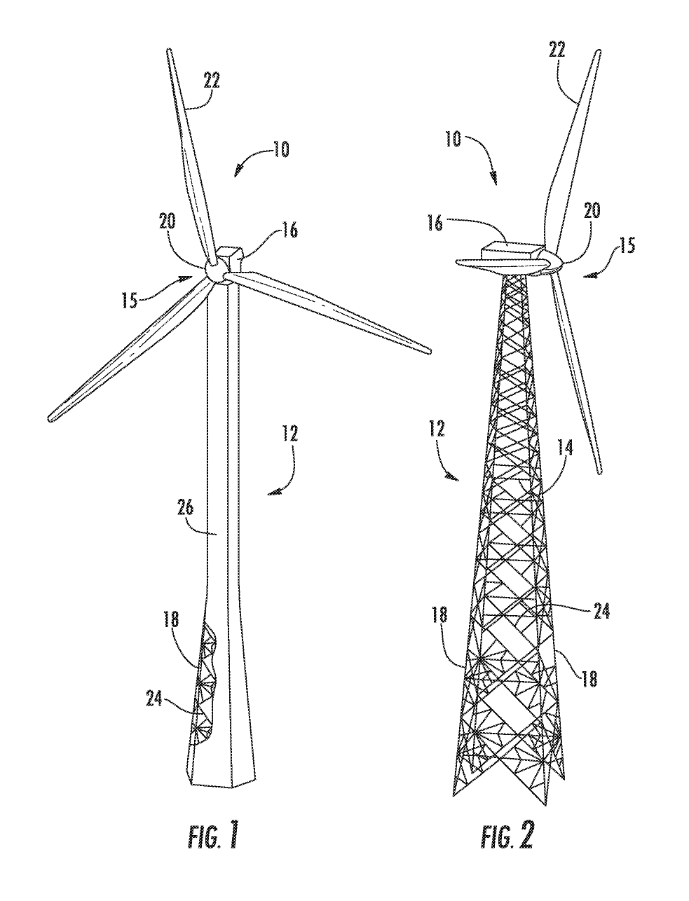

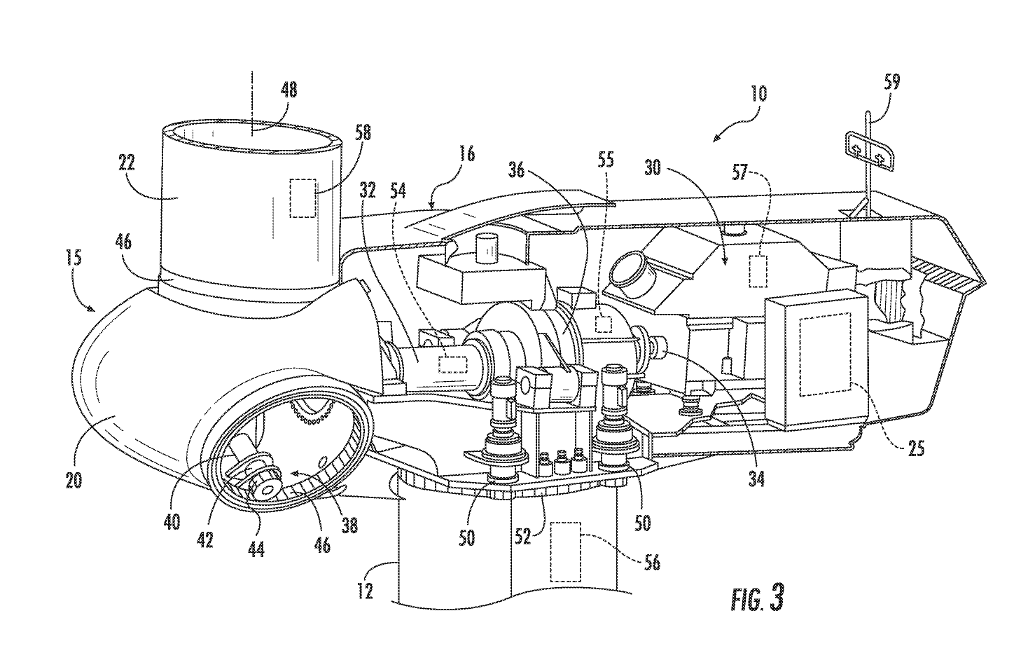

Referring now to the drawings, FIGS. 1 and 2 are perspective views of exemplary wind turbines 10 according to the present disclosure. As shown, the wind turbines 10 include a rotor 15 having a rotatable hub 20 with a plurality of rotor blades 22 mounted to and extending therefrom. Further, the hub 20 is rotationally supported by any manner of power generation components housed within a nacelle 16, as is well known in the art. The nacelle 16 is supported atop a tower structure 12, which in the illustrated embodiments is an open lattice structure formed by legs 18, horizontal braces 14, and diagonal braces 24. The legs 18 are typically angle iron members or pipe members, and the braces 14, 24 are typically angle iron members. These lattice frame tower structures 12 are also referred to in the art as “space frame” towers. The lattice tower structure 12 may be fabricated in sections and erected at the wind turbine site. In the embodiment of FIG. 1, a cladding material 26 may be applied over the lattice structure, which may be any type of suitable fabric, such as an architectural fabric designed for harsh weather conditions. Thus, the cladding 26 is configured to protect workers and equipment within the tower 12. In addition, the cladding 26 provides an aesthetic appearance to the wind turbine 10.

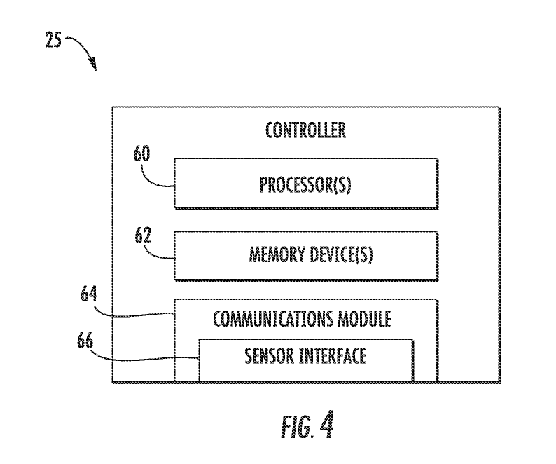

Referring now to FIG. 3, the wind turbine 10 as described herein may also include a controller 25 configured to control the various components of the turbine 10. More specifically, as shown, a simplified, internal view of one embodiment of the nacelle 16 of the wind turbine 10 shown in FIGS. 1 and 2 is depicted, particularly illustrating example components that may be controlled via the controller 25. As shown, a generator 30 may be disposed within the nacelle 16 and may be coupled to the rotor 15 for producing electrical power from the rotational energy generated by the rotor 15. For example, as shown in the illustrated embodiment, the rotor 15 may include a rotor shaft 32 coupled to the hub 20 for rotation therewith. The rotor shaft 32 may, in turn, be rotatably coupled to a generator shaft 34 of the generator 30 through a gearbox 36. As is generally understood, the rotor shaft 32 may provide a low speed, high torque input to the gearbox 36 in response to rotation of the rotor blades 22 and the hub 20. The gearbox 36 may then be configured to convert the low speed, high torque input to a high speed, low torque output to drive the generator shaft 34 and, thus, the generator 30.

Each rotor blade 22 may also include a pitch drive mechanism 38 configured to rotate each rotor blade 22 about its pitch axis 48. Further, each pitch adjustment mechanism 38 may include a pitch drive motor 40 (e.g., any suitable electric motor), a pitch drive gearbox 42, and a pitch drive pinion 44. In such embodiments, the pitch drive motor 40 may be coupled to the pitch drive gearbox 42 so that the pitch drive motor 40 imparts mechanical force to the pitch drive gearbox 42. Similarly, the pitch drive gearbox 42 may be coupled to the pitch drive pinion 44 for rotation therewith. The pitch drive pinion 44 may, in turn, be in rotational engagement with a pitch bearing 46 coupled between the hub 20 and a corresponding rotor blade 22 such that rotation of the pitch drive pinion 44 causes rotation of the pitch bearing 46. Thus, in such embodiments, rotation of the pitch drive motor 40 drives the pitch drive gearbox 42 and the pitch drive pinion 44, thereby rotating the pitch bearing 46 and the rotor blade 22 about the pitch axis 48. Similarly, the wind turbine 10 may include one or more yaw drive mechanisms 50 communicatively coupled to the controller 25, with each yaw drive mechanism(s) 50 being configured to change the angle of the nacelle 16 relative to the wind (e.g., by engaging a yaw bearing 52 of the wind turbine 10).

In addition, the wind turbine 10 may also include one or more sensors (e.g. 54, 55, 56, 57, 58, 59, 102, 104) for measuring various loading and/or operating conditions of the wind turbine 10. The term “operating condition” as used herein may refer to any operating parameter that relates to operation of the wind turbine 10 so as to provide information regarding operational state of the wind turbine 10. For instance, operating conditions may include, but are not limited to, a pitch angle, a generator torque, a generator speed, a power output, or similar. Further, the term “loading condition” as used herein generally refers to any loading condition acting on one of the various wind turbine components. For example, loading conditions may include a torsional movement, a stress, a strain, a twist, a moment, a force, or similar. Further, the loading and/or operating conditions may also include derivatives of any measured loading and/or operating conditions (e.g., blade velocity, acceleration, etc.). In addition, the sensors 54, 55, 56, 57, 58, 59 described herein may include any suitable sensors known in the art. For example, in certain embodiments, the sensors may include one or more of the following: angular accelerometers, linear accelerometers, vibration sensors, angle of attack sensors, camera systems, fiber optic systems, gyroscopes, strain gauges, Miniature Inertial Measurement Units (MIMUs), Light Detection and Ranging (LIDAR) sensors, Sonic Detection and Ranging (SODAR) sensors, anemometers, or similar.

More specifically, as shown, the sensors may include blade sensors 58 for monitoring the rotor blades 22; generator sensors 57 for monitoring the torque, the rotational speed, the acceleration and/or the power output of the generator 30; wind sensors 59 for monitoring the wind speed; and/or shaft sensors 54 for measuring the loads acting on the rotor shaft 32 and/or the rotational speed of the rotor shaft 32. Additionally, the wind turbine 10 may include one or more tower sensors 56 for measuring the loads transmitted through the tower 12 and/or the acceleration of the tower 12. Of course, the wind turbine 10 may further include various other suitable sensors for measuring any other suitable loading and/or operating conditions of the wind turbine 10. For example, the wind turbine 10 may also include one or more sensors 55 (e.g., accelerometers) for monitoring the acceleration of the gearbox 36 and/or the acceleration of one or more structural components of the machine head (e.g., the generator frame, the main frame or bedplate, etc.).

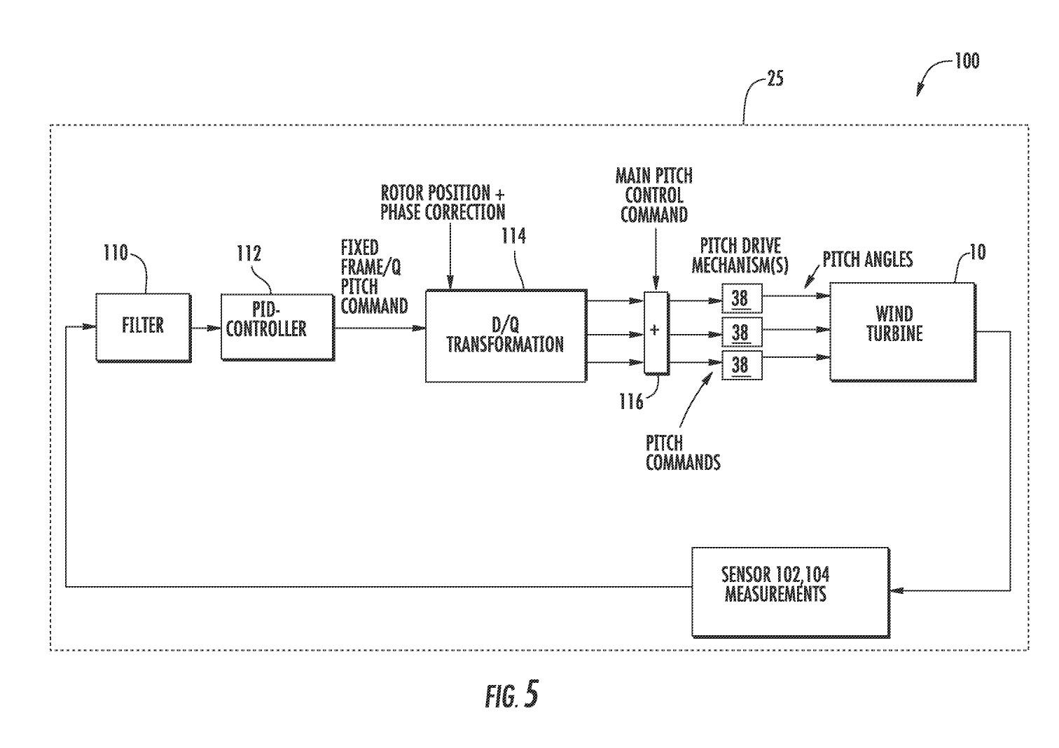

Referring now to FIG. 4, there is illustrated a block diagram of one embodiment of suitable components that may be included within the controller 25 in accordance with aspects of the present subject matter. As shown, the controller 25 may include one or more processor(s) 60 and associated memory device(s) 62 configured to perform a variety of computer-implemented functions (e.g., performing the methods, steps, calculations and the like and storing relevant data as disclosed herein). Additionally, the controller 25 may also include a communications module 64 to facilitate communications between the controller 25 and the various components of the wind turbine 10. Further, the communications module 64 may include a sensor interface 66 (e.g., one or more analog-to-digital converters) to permit signals transmitted from the sensors) to be converted into signals that can be understood and processed by the processors 60. It should be appreciated that the sensors as described herein may be communicatively coupled to the communications module 64 using any suitable means. For example, the sensors may be coupled to the sensor interface 66 via a wired connection. However, in alternative embodiments, the sensors may be coupled to the sensor interface 66 via a wireless connection, such as by using any suitable wireless communications protocol known in the art.

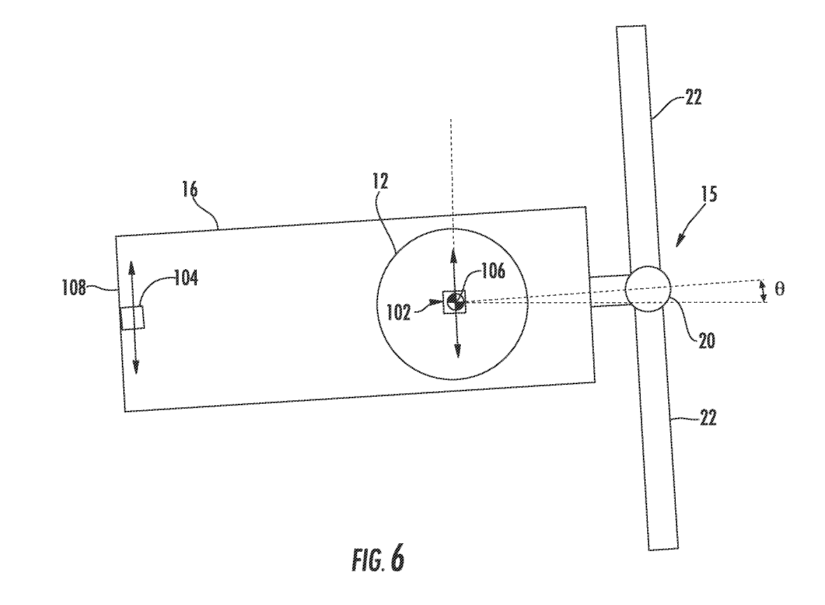

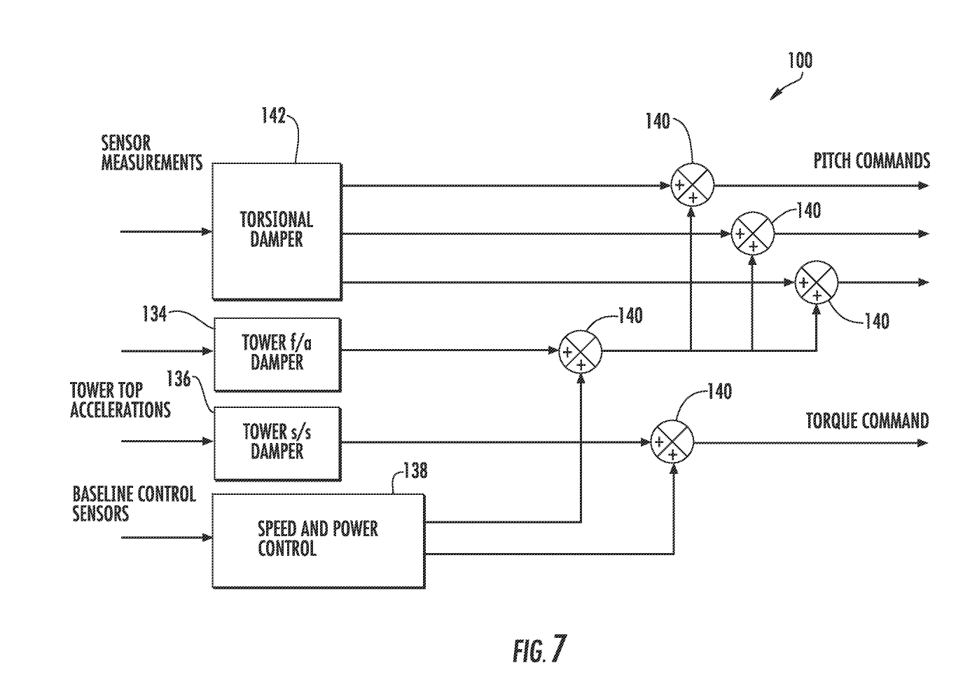

Referring now to FIGS. 5 and 6, a schematic diagram of one embodiment of a system 100 for reducing vibrations of a tower of a wind turbine (e.g. the tower 12 of wind turbine 10) that may be implemented by the controller 25 is illustrated. As shown in the illustrated embodiment, the system 100 may correspond to a closed-loop control scheme that provides continuous and/or active tower torsion damping for the wind turbine 10. More specifically, as shown in FIG. 5, the system 100 receives a plurality of sensor measurements (e.g. from sensors 102, 104 of FIG. 6) that represent a torsional movement of the tower 12. More specifically, as mentioned, the sensors 102, 104 may be communicatively coupled to the controller 25 (e.g. via sensor interface 66) such that the controller 25 can perform one or more operations using the sensor measurements. Thus, in one embodiment, the system 100 may be configured to continuously determine the torsional movement of the tower 12 by measuring a first movement (e.g. via sensor 102) at a first location of the wind turbine 10 and a second movement (e.g. via sensor 104) at a second location of the wind turbine, and subtracting the measured first movement from the measured second movement. More specifically, as shown in FIG. 6, the first location may correspond to a tower center 106 of the tower 12, whereas the second location may include a posterior or anterior side of the nacelle 16 depending on the wind turbine configuration. In certain embodiments, the posterior side of the nacelle 16 generally refers to the side of the nacelle 16 that is opposite to the rotor 15 of the wind turbine 10.

In an alternative embodiment, the system 100 may be configured to continuously determine the torsional movement of the tower 12 by measuring, via one or more sensors 102, 104, an angular acceleration of the tower 12. For example, as shown in FIG. 6, sensor 102 may be configured to determine a torsional movement (i.e. an angular rotation 0) of the top of the nacelle 16 with respect to the tower center 106. In yet another embodiment, the system 100 may be configured to continuously determine the torsional movement of the tower 12 via one or more of the yaw drive mechanisms 50.

In additional embodiments, as shown in FIG. 5, the system 100 may also include one or more filters 110 configured to filter the sensor measurements obtained from the sensors (e.g. 56, 102, 104). It should be understood that the filter(s) may be any suitable filter known in the art. More specifically, in certain embodiments, the filter(s) may include a notch filter, a low-pass filter, a high-pass filter, or combinations thereof.

Still referring to FIG. 5, the filtered sensor measurements may then be sent through a secondary control device 112. In certain embodiments, the secondary control device 112 may be any of the following: a proportional (P) controller, a proportional integral (PI) controller, a proportional derivative (PD) controller, a proportional integral derivative (PID) controller, or similar. For example, as shown in the illustrated embodiment, the secondary control device 112 corresponds to a PID controller, which is generally understood to be a control loop feedback mechanism that determines or calculates an error value based on the difference between a measured process variable and a desired set point. As such, a PID controller attempts to minimize the error by adjusting the process through the use of a manipulated variable. Thus, in some embodiments, the PID controller 112 is configured to determine a fixed frame control action (e.g. a fixed frame/Q pitch command) based on the difference between the sensor measurements and an allowable torsional movement of the tower 12.

Based on the fixed frame control action command, the controller 25 is configured to continuously determine one or more pitch commands 116 for one or more of the pitch drive mechanisms 38 of the wind turbine 10. For example, as shown in embodiment of FIG. 5, the fixed frame control action, which represents a three-phase system, may be transformed into a direct-quadrature (d-q) rotating reference frame. Thus, the system 100 is configured to determine the main pitch control command 116 that can be subsequently sent to each of the pitch drive mechanisms 38 as individual pitch commands. Accordingly, the pitch device mechanisms 38 can alter the pitch angles of each of the rotor blades 22 (as needed) so as to dampen the torsional movement of the tower 12.

More specifically, in certain embodiments, the system 100 may be configured to continuously determine the control command (e.g. the main pitch control command 116) for the pitch drive mechanism(s) 38 by determining a yaw moment of the wind turbine 10 as a function of the torsional movement. Further, the system 10 may determine a damper command for the wind turbine 10 based on the yaw moment. Thus, the damper command sent to each of the pitch device mechanism(s) 38 is configured to alter the pitch angles of each of the rotor blades 22 as needed so as to dampen the torsional movement of the tower 12. In addition, in certain embodiments, the damper command may be added as an offset to existing pitch commands so as to counter or offset torsional movement of the tower 12. As used herein, the yaw moment of the tower generally refers to a loading of a rotor of the wind turbine caused by rotor asymmetry.

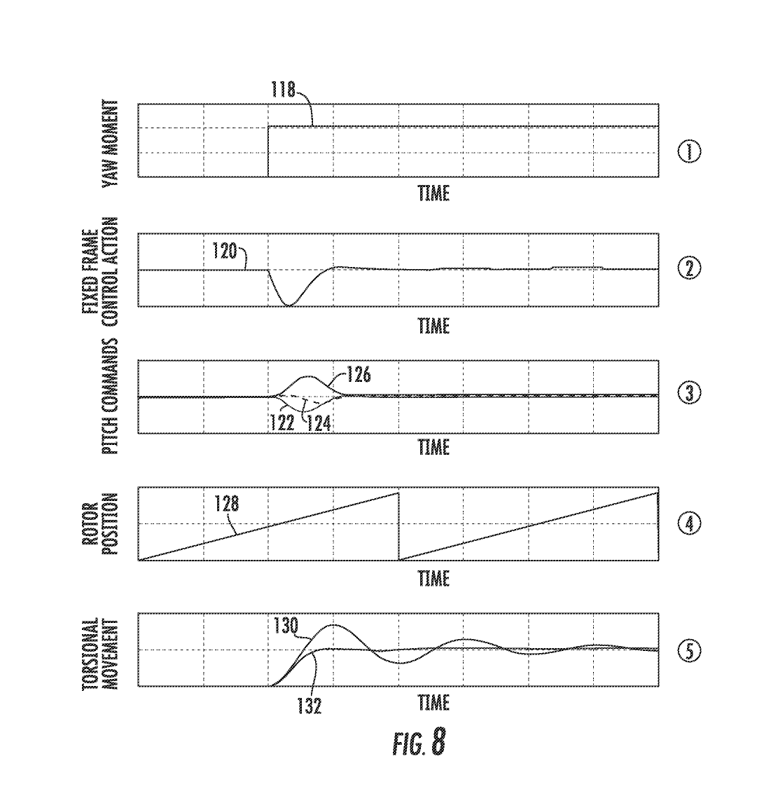

For example, as shown in FIG. 7, a schematic diagram of another embodiment of the system 100 for reducing vibrations of the wind turbine 10 according to the present disclosure is illustrated. As shown, the system 100 may include a torsional damper 142 that is configured to receive one or more sensor measurements, i.e. torsional movement signals. In addition, the system 100 may optionally include a tower fore/aft damper 134 and a tower side/side damper 136. Thus, the tower fore/aft damper 134 and the tower side/side damper 136 are configured to receive tower top accelerations, respectively. In addition, a speed and power control 138 is configured to receive one or more baseline control sensor measurements. The system 100 is then configured to process the data to determine one or more pitch commands and/or a torque command for the wind turbine 10 based, at least in part, on the torsional movement signals. More specifically, as shown, the system 100 may include one or more comparators 140 configured to process the data to determine the pitch command(s) and/or the torque command for the wind turbine 10. As such, in certain embodiments, the pitch commands can be added to the main pitch control commands, e.g. for speed control. As such, the pitch commands provide offset angles to existing pitch angle set points of the controller 25.

Referring now to FIG. 8, various graphs depicting the effects implementing the system 100 for active torsional damping of a wind turbine tower 12 according to the present disclosure are illustrated. More specifically, graph (1) illustrates the yaw moment 118 versus time; graph (2) illustrates the fixed frame control action 120 versus time; graph (3) illustrates the pitch commands for the three different rotor blades 22 of the wind turbine 10 (e.g. 122, 124, 126) versus time; graph (4) illustrates the rotor position 128 of the wind turbine 10 versus time; and graph (5) illustrates the torsional movement for a damped 132 wind turbine and un-damped 130 wind turbine versus time. As shown, the yaw moment 118 (graph (1)) results in three different pitch commands 122, 124, 126 (graph (3)) for each of the rotor blades 22 of the wind turbine so as to dampen the torsional movement of the tower 12 (graph (5)).

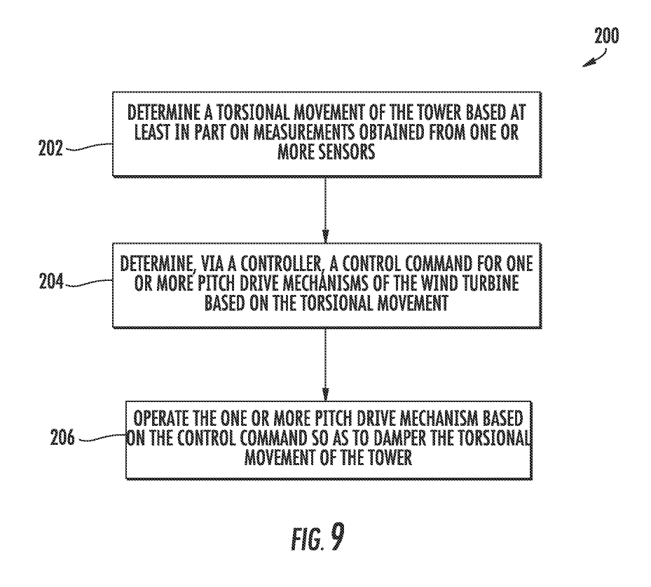

Referring now to FIG. 9, a flow diagram of one embodiment of a method 200 for reducing vibrations of a tower (e.g. a tubular steep tower or a lattice tower structure) of a wind turbine 10 is illustrated. As shown at 202, the method 200 includes determining a torsional movement of the tower based at least in part on measurements obtained from one or more sensors. As shown at 204, the method 200 determining, via a controller, a control command for one or more pitch drive mechanisms of the wind turbine based on the torsional movement. Thus, at 206, the method 200 also includes operating the one or more pitch drive mechanisms based on the control command so as to dampen the torsional movement of the tower.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A method for reducing vibrations of a tower of a wind turbine, the method comprising:
continuously determining a torsional movement of the tower based at least in part on measurements obtained from one or more sensors;
continuously determining, via a controller, a control command for one or more pitch drive mechanisms of the wind turbine based on the torsional movement; and,
operating the one or more pitch drive mechanisms based on the control command so as to dampen the torsional movement of the tower.

2. The method of claim 1, wherein continuously determining the torsional movement of the tower further comprises:
measuring, via one or more linear acceleration sensors, a first movement at a first location of the wind turbine,
measuring, via one or more linear acceleration sensors, a second movement at a second location of the wind turbine, and
subtracting the measured first movement from the measured second movement.

3. The method of claim 2, wherein the first location comprises a tower center and the second location comprises at least one of a posterior side of the nacelle or an anterior side of the nacelle.

4. The method of claim 1, wherein continuously determining the torsional movement of the tower further comprises measuring, via one or more sensors, an angular movement of the tower.

5. The method of claim 1, further comprising filtering the measurements obtained from the one or more sensors.

6. The method of claim 1, wherein continuously determining the control command for one or more pitch drive mechanisms of the wind turbine based on the torsional movement further comprises:
determining a yaw moment of the wind turbine as a function of the torsional movement, and
determining a damper command for the wind turbine based on the yaw moment so as to counter the torsional movement.

7. The method of claim 6, wherein operating the one or more pitch drive mechanisms based on the control command so as to dampen the torsional movement of the tower further comprises:
operating the one or more pitch drive mechanisms based on the damper command.

8. The method of claim 6, wherein the yaw moment of the tower corresponds to a loading of a rotor of the wind turbine caused by rotor asymmetry.

9. The method of claim 1, further comprising continuously determining the torsional movement of the tower via one or more yaw drive mechanisms.

10. A method for actively controlling a wind turbine so as to reduce vibrations of a tower of the wind turbine, the method comprising:
continuously determining, via one or more pitch drive mechanisms, a torsional movement of the tower;
continuously determining a yaw moment of the wind turbine as a function of the torsional movement;
continuously determining a damper command for the wind turbine based on the yaw moment; and,
controlling, via the one or more pitch drive mechanisms, the wind turbine based on the damper command so as to dampen the torsional movement of the tower.

11. A system for reducing vibrations of a tower of a wind turbine, the system comprising:
one or more sensors configured to measure a torsional movement of the tower;
a controller communicatively coupled with the one or more sensors, the controller configured to perform one or more operations, the operations comprising:
continuously determining a torsional movement of the tower based at least in part on measurements obtained from one or more sensors,
continuously determining, via a controller, a control command for one or more pitch drive mechanisms of the wind turbine based on the torsional movement, and
operating the one or more pitch drive mechanisms based on the control command so as to dampen the torsional movement of the tower.

12. The system of claim 11, wherein continuously determining the torsional movement of the tower further comprises:
measuring, via one or more linear acceleration sensors, a first movement at a first location of the wind turbine,
measuring, via one or more linear acceleration sensors, a second movement at a second location of the wind turbine, and
subtracting the measured first movement from the measured second movement.

13. The system of claim 12, wherein the first location comprises a tower center and the second location comprises at least one of a posterior side of the nacelle or an anterior side of the nacelle.

14. The system of claim 11, wherein continuously determining the torsional movement of the tower further comprises measuring, via the one or more sensors, an angular movement of the tower.

15. The system of claim 11, further comprising one or more filters configured to filter the measurements obtained from the one or more sensors, wherein the one or more filters comprise at least one of a notch filter, a low-pass filter, a high-pass filter, or combinations thereof.

16. The system of claim 11, wherein continuously determining the control command for one or more pitch drive mechanisms of the wind turbine based on the torsional movement further comprises:
determining a yaw moment of the wind turbine as a function of the torsional movement, wherein the yaw moment of the tower corresponds to an asymmetric loading of a rotor of the wind turbine, and
determining an damper command for of the wind turbine based on the yaw moment.

17. The system of claim 11, wherein operating the one or more pitch drive mechanisms based on the control command so as to dampen the torsional movement of the tower further comprises:
operating the one or more pitch drive mechanisms based on the damper command.

18. The system of claim 11, wherein the controller further comprises at least one or more of the following control devices: a proportional (P) controller, a proportional integral (PI) controller, a proportional derivative (PD) controller, or a proportional integral derivative (PID) controller.

19. The system of claim 11, wherein the one or more sensors comprise one or more of the following: angular accelerometers, linear accelerometers, vibration sensors, angle of attack sensors, camera systems, fiber optic systems, gyroscopes, strain gauges, Miniature Inertial Measurement Units (MIMUs), Light Detection and Ranging (LIDAR) sensors, or Sonic Detection and Ranging (SODAR) sensors.

20. The system of claim 11, wherein the tower comprises a lattice tower structure.
